(19) United States
(12) Patent Application Publication
(10) Pub. No.: US 2005/0036708 A1
(43) Pub. Date: Feb. 17, 2005

(54) Systems and methods for cropping captured images

(76) Inventor: David Boll, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/638,770

(22) Filed: Aug. 11, 2003

(51) Int. Cl. G06K 9/46; G06T 7/00; H04N 1/387; G06K 9/78

(52) U.S. Cl. 382/283; 382/199; 382/203; 358/453

(57) ABSTRACT

Disclosed are systems and methods for cropping captured images. In one embodiment, a system and a method pertain to capturing an image of a document to be captured, analyzing the captured image to detect human hands, identifying an imaginary rectangle defined by the detected human hands, and cropping the captured image.

### BACKGROUND

Currently, digital image cropping is performed after a digital image is already captured and downloaded to a computer. For instance, a user may crop an image, which was scanned with a scanner or captured with a digital camera, using an appropriate image manipulation application that executes on a computer (e.g., a personal computer (PC)). In such a case, the user must normally define a rectangle around the portion of the image the user would like to preserve, such that the area outside of the rectangle will be excluded from a final scan or discarded from the finally-captured image. This process may involve, for instance, (1) choosing a cropping feature either from the menu or by selecting a “crop” button; (2) indicating the desired amount of cropping by dragging a box around the image; and (3) saving the cropped image.

Although the above-described process is effective, it is somewhat manually intensive and therefore can be tedious for the user. In addition, it requires the user to crop an image after the image is captured and downloaded, as opposed to enabling the user to identify desired (as well as undesired) portions of a scene during the capturing process.

### SUMMARY

Disclosed are systems and methods for cropping captured images. In one embodiment, a system and a method pertain to capturing an image of a document to be captured, analyzing the captured image to detect human hands, identifying an imaginary rectangle defined by the detected human hands, and cropping the captured image.

### BRIEF DESCRIPTION OF THE DRAWINGS

The accompanying drawings incorporated in and forming a part of the specification illustrate several aspects of the disclosed systems and methods. These drawings are not necessarily to scale.

FIG. 1 illustrates an embodiment of a system for capturing and cropping images.

FIG. 2 is a block diagram of an embodiment of an architecture for the system shown in FIG. 1.

FIG. 3 is a flow diagram illustrating an embodiment of a method for capturing and cropping images.

FIG. 4 is a schematic depiction illustrating a user indicating a portion of a document to retain after image capture.

FIG. 5 illustrates a cropped image that results from the indication in FIG. 4.

FIG. 6 is a schematic depiction illustrating a user indicating a portion of a document to retain after image capture.

FIG. 7 illustrates a full image that results from the indication in FIG. 6.

FIG. 8 is a flow diagram illustrating an embodiment of operation of an image cropping system shown in FIG. 2.

### DETAILED DESCRIPTION

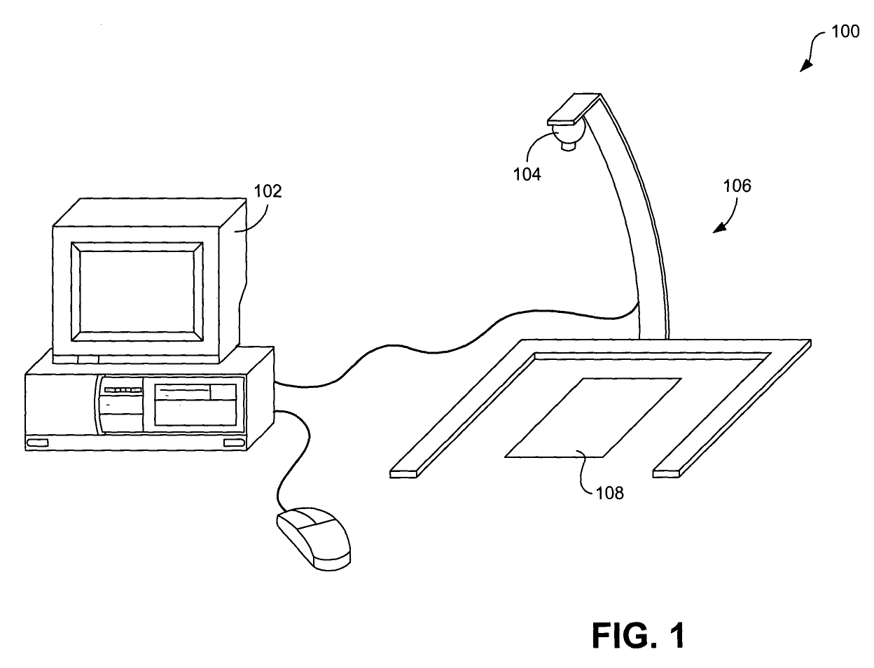

The disclosed systems and methods will now be described in detail with specific reference to the drawings. Turning FIG. 1, illustrated is a system 100 for capturing and cropping images. As indicated in that figure, the system 100 comprises a computer 102, such as a desktop computer, and an image capture device 104 that is connected to the computer. In the embodiment of FIG. 1, the image capture device 104 comprises a so-called “eyeball” digital camera that is controlled and operated using the computer 102. Although such a dependent image capture device is illustrated in FIG. 1 and has been identified herein, the image capture device 104 can, alternatively, comprise an independent image capture device, such as a portable digital camera.

As is further illustrated in FIG. 1, the image capture device 104 is physically supported by a stand 106 such that the image capture device is elevated off of and is directed toward an image capture area that, for example, comprises a portion of the desktop. As indicated in FIG. 1, a document 108 to be captured (e.g., textural and/or graphical document or a photograph) can be placed in the image capture area for capturing by the image capture device 104.

The image capture device 104 can communicate with the computer 102 in various ways. For instance, the image capture device 104 can directly connect to the computer 102 using a cable (e.g., a universal serial bus (USB) cable) that can be plugged into the computer. Alternatively, the image capture device 104 can indirectly “connect” to the computer 102 via wireless communication (e.g., short-range radio frequency (RF) communications).

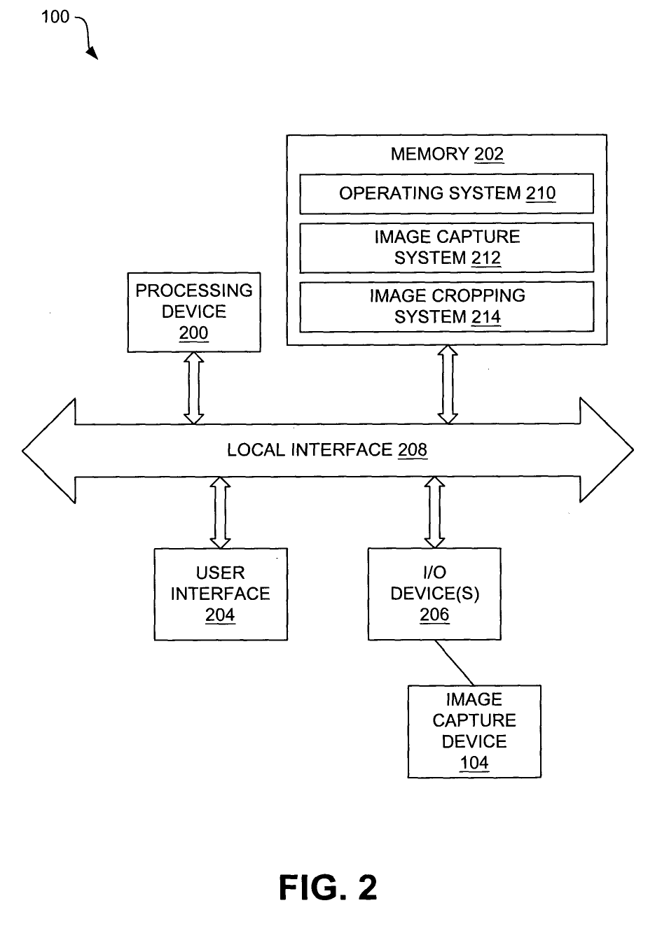

FIG. 2 is a block diagram illustrating an example architecture for the system 100 shown in FIG. 1. More particularly, FIG. 2 illustrates an example architecture for the computer 102 as connected to the image capture device 104. As indicated in FIG. 2, the computer 102 comprises a processing device 200, memory 202, a user interface 204, and at least one I/O device 206, each of which is connected to a local interface 208.

The processing device 200 can include a central processing unit (CPU) or an auxiliary processor among several processors associated with the computer 102, or a semiconductor based microprocessor (in the form of a microchip). The memory 202 includes any one of or a combination of volatile memory elements (e.g., RAM) and nonvolatile memory elements (e.g., read only memory (ROM), hard disk, tape, etc.).

The user interface 204 comprises the components with which a user interacts with the computer 102, such as a keyboard and mouse, and a device that provides visual information to the user, such as a cathode ray tube (CRT) or liquid crystal display (LCD) monitor.

With further reference to FIG. 2, the one or more I/O devices 206 are adapted to facilitate communication with other devices, including the image capture device 104. By way of example, the I/O devices 206 may include one or more of a USB, Firewire, or small computer system interface (SCSI) connection component and/or communication components such as a wireless (e.g., RF) transceiver.

The memory 202 comprises various programs including an operating system 210, an image capture system 212, and an image cropping system 214. The operating system 210 controls the execution of other programs and provides scheduling, input-output control, file and data management, memory management, and communication control and related services. The image capture system 212 is configured to facilitate image capture. In particular, the image capture system 212 is configured to control and operate the image capture device 104 to capture image data, and may further be configured to process any image data so captured.

The image cropping system 214 is configured to crop images captured with the image capture device 104. As is described in greater detail below, the image cropping system 214 is configured to detect the hands of a user in the image capture area relative to a document to be captured and crop an image of the document relative to an imaginary rectangle defined by those hands. Notably, when the image capture device comprises an independent image capture device, such as a portable digital camera, the image cropping system 214 may be stored and may execute on the image capture device. In such cases, the image capture device may be used independently to crop images as they are captured in accordance with the user's preferences.

Various programs (i.e., logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

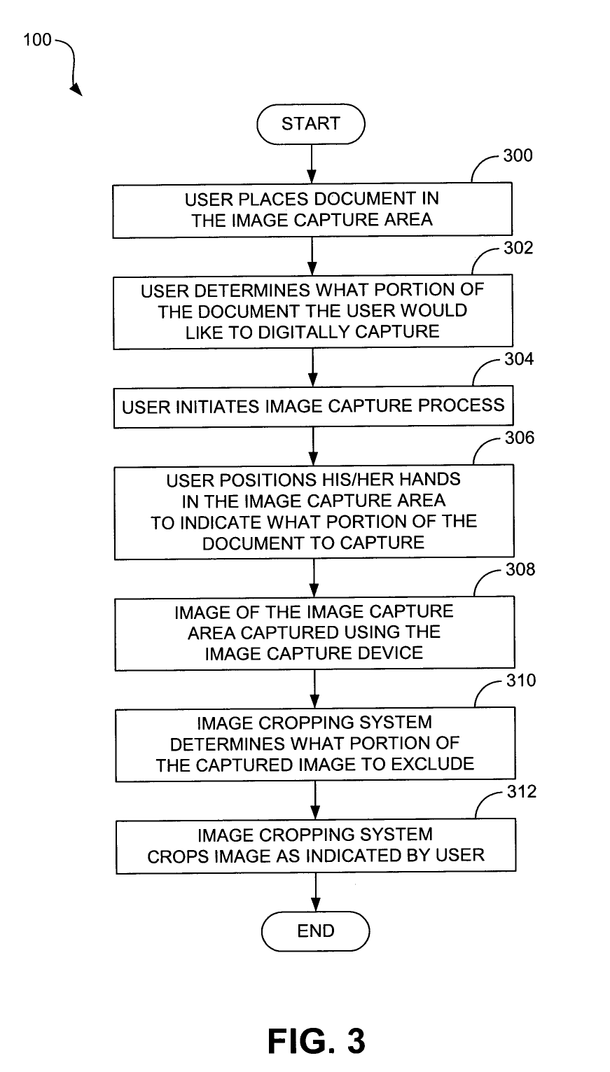

FIG. 3 provides an overview of an embodiment for capturing and cropping an image using the system 100. In particular, FIG. 3 provides an overview of a method for capturing and cropping an image as indicated by a user during the image capture process. Beginning with block 300 of FIG. 3, the user places a document in the image capture area at which the image capture device 104 is or will be directed. By way of example, the document comprises a textual and/or graphical document, such as a word processing document, or a photograph. Next, the user determines what portion of the document the user would like to digitally capture, as indicated in block 302. Notably, this portion can be a fraction of the document, or the entire document, if desired.

Once the determination has been made as to what portion of the document to capture, the user can initiate the image capture process, as indicated in block 304. By way of example, this initiation can be effected through input of an appropriate command entered using the computer user interface 204. Alternatively, when the image capture device is an independent image capture device, such as a portable digital camera, initiation of the image capture process can comprise depression of a shutter button of the camera. To provide the user with enough time to indicate which portion of the document to capture, an image may not be immediately captured after image capture is initiated. For example, image capture may be delayed a few seconds after the image capture command is received.

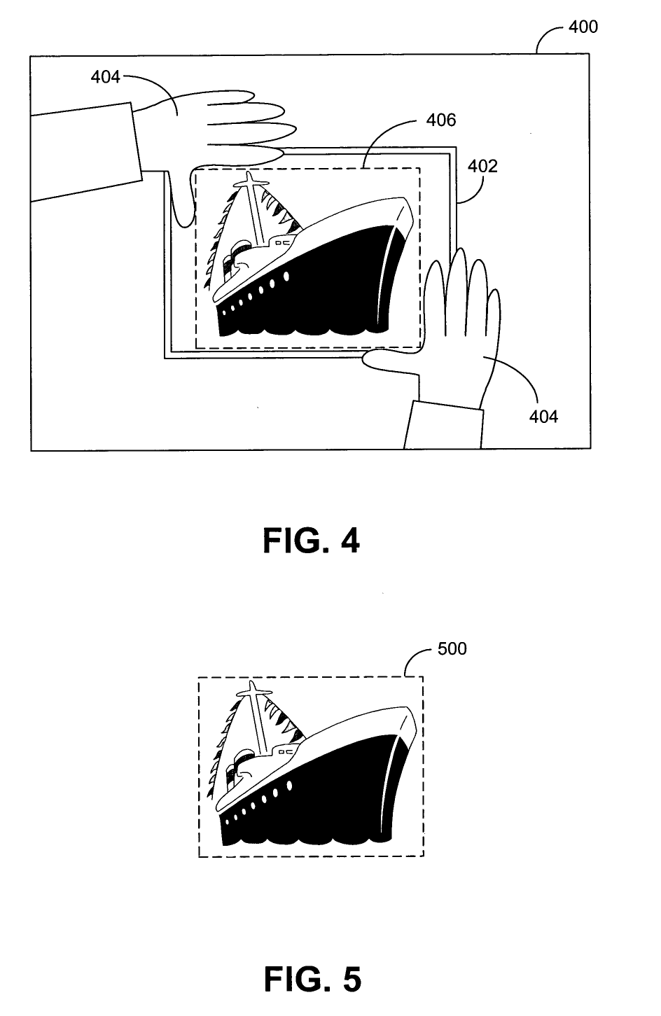

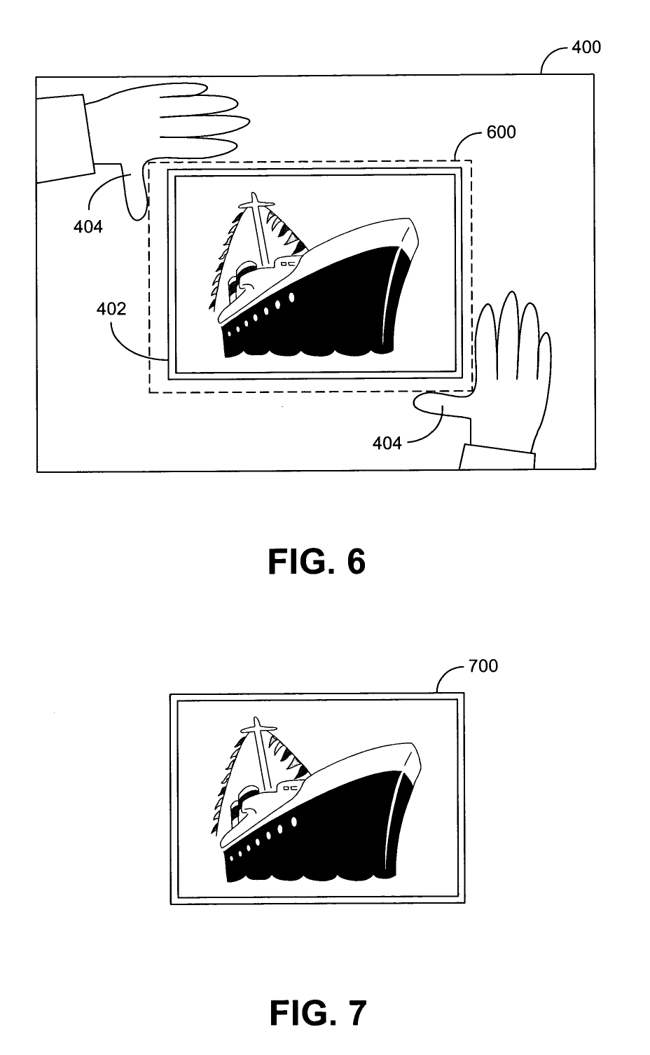

Next, with reference to block 306, the user positions his or her hands in the image capture area so as to provide an indication as to the portion of the document that is to be captured. By way of example, this positioning can comprise defining an imaginary rectangle with the user's hands that indicates that content contained within the imaginary rectangle is to be included and content beyond the boundaries of the imaginary rectangle is to be excluded, thereby providing cropping instructions to the image cropping system 214. Examples of such hand positioning are provided in FIGS. 4 and 6.

FIG. 4 illustrates an image capture area 400 that presumably is within an image plane in which the image capture device 104 can capture image data. A document 402 has been placed within the image capture area 400. In the example of FIG. 4, the document 402 comprises a hard copy photograph that is to comprise the subject of the image capturing. As is apparent from FIG. 4, a user has placed his hands 404 over the document 402 in a manner so as to define an imaginary rectangle 406 that in turn defines the boundaries of the image data that is to be retained. In such a case, a portion of the document 402 is to be cropped.

FIG. 6 illustrates an alternative positioning of the user's hands 404. In the embodiment of FIG. 6, the user has placed his hands 404 so as to define an imaginary rectangle 600 that encompasses the entire document 402. In such a case, the entire document 402 is to be retained.

Returning to FIG. 3, an image of the image capture area is captured using the image capture device 104, as indicated in block 308. In that the image capture device 104 is configured and positioned so as to capture the entire image capture area, such image capture results in the user's hands being captured along with the document. Next, as indicated in block 310, the image cropping system 214 determines what portion of the captured image to exclude. That determination is made in relation to the positioning of the user's hands. In particular, the image cropping system 214 identifies the imaginary rectangle formed by the user's hands and uses that rectangle as a guide that indicates what portion of the captured image data to exclude (i.e., at least all portions beyond the boundaries of the imaginary rectangle).

Once the exclusion determination is made, the image cropping system 214 crops the image as indicated by the user, as indicated in block 312. Such cropping may comprise cropping a portion of the document so that only a fraction of the document is retained as an image. For example, in the case of FIG. 4 in which the user's hands 404 overlapped the document 402, only the portion of the document that was contained within the imaginary rectangle 406 is retained so as to result in a cropped image 500 shown in FIG. 5. Such “cropping” may alternatively comprise cropping only the area that surrounds the document. For example, in the case of FIG. 6 in which the user's hands 404 define an imaginary rectangle 600 that encompasses the entire document 402, the area surrounding the document is cropped while the entire document is retained so as to result in a full image 700 of the document as indicated in FIG. 7.

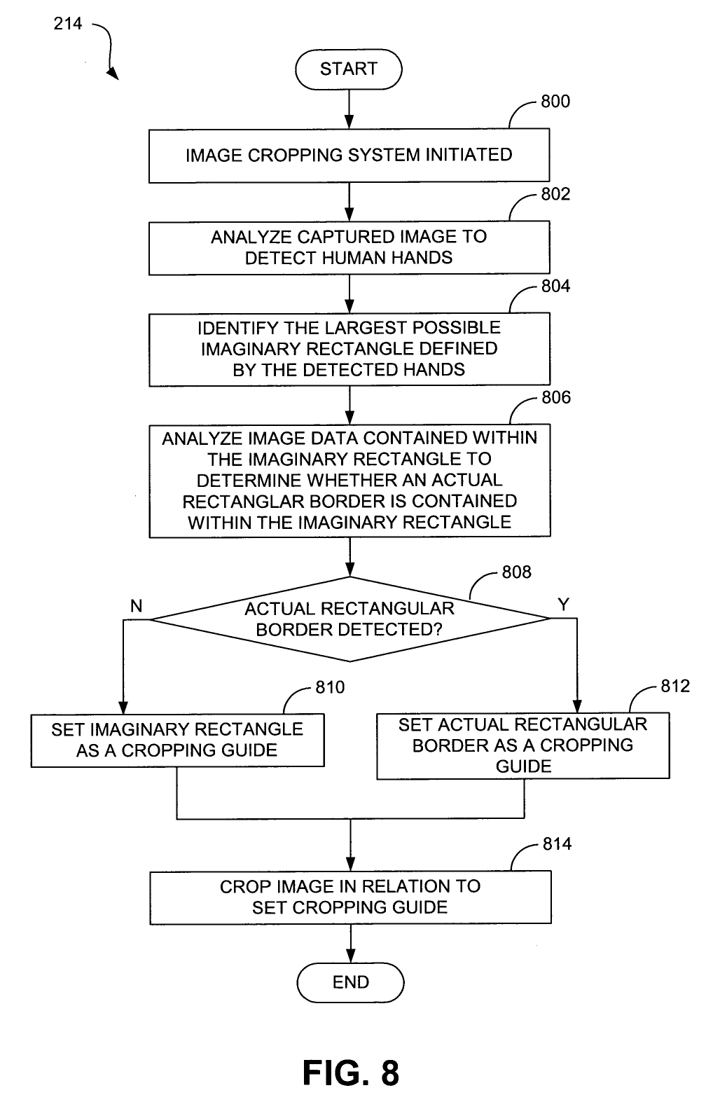

FIG. 8 provides an example of operation of the image cropping system 214. As noted above, this system 214 may execute on a computer (e.g., computer 102) or may execute on an independent image capture device, such as a portable digital camera. Beginning with block 800 of FIG. 8, the image cropping system 214 is initiated. This initiation can occur, for example, upon an image being captured by the image capture device when the device is in a cropping mode. Next, with reference to block 802, the image cropping system 214 analyzes a captured image to detect human hands. Such detection is accomplished by analyzing the image data of the captured image to identify at least one of the color, size, shape, and aspect ratios of typical human hands.

Assuming that human hands are detected, the image cropping system 214 identifies the largest possible imaginary rectangle that is defined by the detected hands, as indicated in block 804. This identification comprises interpreting the orientation of the detected hands to determine the size and orientation of a rectangle that is being indicated by the hands. By way of example, the image cropping system 214 can be configured to define the borders of the imaginary rectangle with reference to the inner edges of the user's thumb and index finger of each hand (see FIGS. 4 and 6).

Next, the image cropping system 214 analyzes the image data contained within the imaginary rectangle to determine whether an actual rectangular border is contained within the imaginary rectangle, as indicated in block 806. Such an actual rectangular border may be detected using known edge detection techniques (e.g., pixel differentiation) in which an abrupt change in pixel color and/or darkness is taken to indicate an edge of an object. If such a border is detected, the border is assumed to comprise the edges of the document such that the user's hands define an imaginary rectangle the encompasses the entire document (see FIG. 6) to indicate that the entire document is to be retained.

With reference to decision block 808, if an actual rectangular border is not detected, flow continues to block 810 at which the imaginary rectangle is set as a cropping guide. If, on the other hand, an actual rectangular border is detected, flow continues to block 812 at which the actual rectangular border is set as the cropping guide. At this point, the image cropping system 214 crops the captured image in relation to the set cropping guide, as indicated in block 814. Therefore, if the user's hands indicated that only a portion of the document was to be retained (FIG. 4), a cropped image of the document results (FIG. 5). If, on the other hand, the user's hands indicated that the entire document was to be retained (FIG. 6), a full image of the entire document results (FIG. 7).

1. A method for cropping images, the method comprising:
capturing an image of a document to be captured;
analyzing the captured image to detect human hands;
identifying an imaginary rectangle defined by the detected hands; and
cropping the captured image.

2. The method of claim 1, wherein capturing an image comprises capturing an image with an image capture device used in conjunction with a computer.

3. The method of claim 1, wherein capturing an image comprises capturing an image with an independent image capture device.

4. The method of claim 1, wherein identifying an imaginary rectangle comprises identifying an imaginary rectangle defined by inner edges of thumbs and index fingers of the detected human hands.

5. The method of claim 1, further comprising analyzing image data contained within the imaginary rectangle to determine whether an actual rectangular border is contained within the imaginary rectangle.

6. The method of claim 5, wherein analyzing image data comprises detecting edges of the document to be captured.

7. The method of claim 5, wherein cropping the captured image comprises excluding image data beyond boundaries of the imaginary rectangle.

8. The method of claim 5, wherein cropping the captured image comprises excluding image data beyond an actual rectangular border contained within the imaginary rectangle.

9. A system for cropping images, the system comprising:
means for capturing an image of an image capture area that includes a document and hands of a user;
means for analyzing the captured image to detect human hands;
means for identifying an imaginary rectangle defined by the detected human hands; and
means for cropping the captured image with reference to the imaginary rectangle.

10. The system of claim 9, wherein the means for capturing an image comprise a camera used in conjunction with a computer.

11. The system of claim 9, wherein the means for capturing an image comprise a portable digital camera.

12. The system of claim 9, wherein the means for identifying an imaginary rectangle comprise means for identifying an imaginary rectangle defined by inner edges of thumbs and index fingers of the detected human hands.

13. The system of claim 9, further comprising means for analyzing image data contained within the imaginary rectangle to determine whether an actual rectangular border is contained within the imaginary rectangle.

14. The system of claim 13, wherein the means for analyzing image data comprise means for differentiating pixels of the captured image to detect edges of the document to be captured.

15. The system of claim 13, wherein the means for cropping comprise means for excluding image data beyond boundaries of the imaginary rectangle.

16. The system of claim 15, wherein the means for cropping comprise means for excluding image data beyond an actual rectangular border contained within the imaginary rectangle.

17. A system for cropping images, the system comprising:
logic configured to analyze a captured image to detect human hands contained within the image;
logic configured to identify an imaginary rectangle defined by the detected human hands; and
logic configured to crop the captured image with reference to the imaginary rectangle.

18. The system of claim 17, wherein the logic configured to identify an imaginary rectangle comprises logic configured to identify an imaginary rectangle defined by inner edges of thumbs and index fingers of the detected human hands.

19. The system of claim 17, further comprising logic configured to analyze image data contained within the imaginary rectangle to determine whether an actual rectangular border is contained within the imaginary rectangle.

20. The system of claim 19, wherein the logic configured to analyze image data comprises logic configured to differentiate pixels of the captured image to detect edges of a document to be captured.

21. The system of claim 19, wherein the logic configured to crop comprises logic configured to exclude image data beyond boundaries of the imaginary rectangle.

22. The system of claim 19, wherein the logic configured to crop comprises logic configured to exclude image data beyond an actual rectangular border contained within the imaginary rectangle.

23. An image cropping system stored on a computer-readable medium, the system comprising:
logic configured to analyze a captured image to detect human hands contained in the captured image;
logic configured to identify an imaginary rectangle defined by the detected human hands;
logic configured to analyze image data contained within the imaginary rectangle to determine whether an actual rectangular border is contained within the imaginary rectangle;
logic configured to set the imaginary rectangle as a cropping guide if an actual rectangular border is not contained within the imaginary rectangle;
logic configured to set an actual rectangular border as a cropping guide if the actual rectangular border is contained within the imaginary rectangle; and
logic configured to crop the captured image using a set cropping guide such that image data beyond boundaries of the guide are not retained.
